(19) United States
(12) Patent Application Publication
(10) Pub. No.: US 2022/0385384 A1
(43) Pub. Date: Dec. 1, 2022

(54) ENHANCEMENT OF CHANNEL STATE INFORMATION ON MULTIPLE TRANSMISSION/RECEPTION POINTS

(71) Applicant: ZTE CORPORATION, Shenzhen (CN)

(72) Inventors: Chuangxin JIANG, Shenzhen (CN); Zhaohua LU, Shenzhen (CN); Hao WU, Shenzhen (CN); Shujuan ZHANG, Shenzhen (CN); Bo GAO, Shenzhen (CN)

(21) Appl. No.: 17/852,223

(22) Filed: Jun. 28, 2022

Related U.S. Application Data
(63) Continuation of application No. PCT/CN2020/074693, filed on Feb. 11, 2020.

(51) Int. Cl. H04B 17/345; H04B 7/0456; H04W 24/10

(52) U.S. Cl. CPC H04B 17/345; H04B 7/0456; H04W 24/10

(57) ABSTRACT

Presented are systems and methods for enhancing channel state information on multiple transmission/reception points. A wireless communication device may receive a reporting setting information for a plurality of associated measurement resources that comprises a first measurement resource for channel measurement, and a second measurement resource. The wireless communication device may perform using precoding information applied on the second measurement resource, interference measurement on the second measurement resource.

### CROSS-REFERENCE TO RELATED APPLICATION

This application claims the benefit of priority under 35 U.S.C. § 120 as a continuation of PCT Patent Application No. PCT/CN2020/074693, filed on Feb. 11, 2020, the disclosure of which is incorporated herein by reference in its entirety.

### TECHNICAL FIELD

The disclosure relates generally to wireless communications, including but not limited to systems and methods for enhancing channel state information on multiple transmission/reception points.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device may receive a reporting setting information for a plurality of associated measurement resources that comprises a first measurement resource for channel measurement, and a second measurement resource. The wireless communication device may perform using precoding information applied on the second measurement resource, interference measurement on the second measurement resource.

In some embodiments, the precoding information may include at least one of a precoding matrix, a precoding matrix indicator, or a rank indicator. In some embodiments, the second measurement resource may include a measurement resource for channel measurement. In some embodiments, the reporting setting information, or a resource setting information configured according to the reporting setting information, may include an association between the first and the second measurement resources.

In some embodiments, the wireless communication device may determine the precoding information according to at least one beam state used for the second measurement resource. Each of the at least one beam state may include quasi-colocation (QCL) or spatial relation configuration. In some embodiments, the wireless communication device may receive a signal transmission corresponding to the first or the second measurement resource according to at least: a first beam state for the first measurement resource and a second beam state for the second measurement resource, each beam state comprising quasi-colocation (QCL) or spatial relation configuration.

In some embodiments, the wireless communication device may report a channel state information (CSI) reference signal (RS) resource indicator, corresponding to associated measurement resources in the plurality of associated measurement resources. In some embodiments, the wireless communication device may report a number of at least one of: rank indicator, precoding matrix indicator or channel quality information, equal to a number of measurement resources in the plurality of associated measurement resources. In some embodiments, the wireless communication device may report a combined channel quality information corresponding to measurement resources in the plurality of associated measurement resources.

In some embodiments, the wireless communication device may determine that the first measurement resource and the second measurement resource are associated, responsive to determining that the first measurement resource and the second measurement resource are configured with a same plurality of beam states. In some embodiments, the reporting setting information, or a resource setting information configured according to the reporting setting information, may indicate that the first measurement resource is in a first set of measurement resources, and the second measurement resource is in a second set of measurement resources at a position corresponding to that of the first measurement resource in the first set.

In some embodiments, the reporting setting information indicates that the second measurement resource has a resource index that is same as that of a third measurement resource which is for channel measurement. In some embodiments, the wireless communication device may determine the precoding information for the second measurement resource according to the third measurement resource.

In some embodiments, the wireless communication device may determine to perform the interference measurement on the second measurement resource, responsive to determining that the first measurement resource and the second measurement resource are configured with a same plurality of beam states. The first measurement resource and the second measurement resource may correspond to different resource settings.

In some embodiments, the wireless communication device may receive a first signal transmission corresponding to the first measurement resource and a second signal transmission corresponding to the second measurement resource, according to a plurality of beam states configured for the first measurement resource. In some embodiments, the wireless communication device may perform using precoding information applied on the second measurement resource, interference measurement on the second measurement resource, responsive to receiving an indication via a higher layer signaling.

In some embodiments, the wireless communication device may perform using precoding information applied on the second measurement resource, interference measurement on the second measurement resource, according to a plurality of beam states configured for the second measurement resource. In some embodiments, the plurality of beam states configured for the second measurement resource is the same as that configured for the first measurement resource.

At least one aspect is directed to a system, method, apparatus, or a computer-readable medium. A wireless communication node may transmit, to a wireless communication device, a reporting setting information for a plurality of associated measurement resources that comprises a first measurement resource for channel measurement, and a second measurement resource. The wireless communication device may be caused to perform interference measurement on the second measurement resource, using precoding information applied on the second measurement resource.

In some embodiments, the precoding information may include at least one of a precoding matrix, a precoding matrix indicator, or a rank indicator. In some embodiments, the second measurement resource may include a measurement resource for channel measurement. In some embodiments, the reporting setting information, or a resource setting information configured according to the reporting setting information, may include an association between the first and the second measurement resources.

In some embodiments, the wireless communication device may be caused to determine the precoding information according to at least one beam state used for the second measurement resource, each of the at least one beam state comprising quasi-colocation (QCL) or spatial relation configuration. In some embodiments, the wireless communication node may send, to the wireless communication device, a signal transmission corresponding to the first or the second measurement resource according to at least: a first beam state for the first measurement resource and a second beam state for the second measurement resource, each beam state comprising quasi-colocation (QCL) or spatial relation configuration.

In some embodiments, the wireless communication node may receive, from the wireless communication device, a channel state information (C SI) reference signal (RS) resource indicator, corresponding to associated measurement resources in the plurality of associated measurement resources. In some embodiments, the wireless communication node may receive, from the wireless communication device, a number of at least one of: rank indicator, precoding matrix indicator or channel quality information, equal to a number of measurement resources in the plurality of associated measurement resources.

In some embodiments, the wireless communication node may receive from the wireless communication device, a combined channel quality information corresponding to measurement resources in the plurality of associated measurement resources. In some embodiments, the wireless communication device may determine that the first measurement resource and the second measurement resource are associated, responsive to determining that the first measurement resource and the second measurement resource are configured with a same plurality of beam states.

In some embodiments, the reporting setting information, or a resource setting information configured according to the reporting setting information, may indicate that the first measurement resource is in a first set of measurement resources, and the second measurement resource is in a second set of measurement resources at a position corresponding to that of the first measurement resource in the first set. In some embodiments, the reporting setting information may indicate that the second measurement resource has a resource index that is same as that of a third measurement resource which is for channel measurement.

In some embodiments, the wireless communication device may be caused to determine the precoding information for the second measurement resource according to the third measurement resource. In some embodiments, the wireless communication device may determine to perform the interference measurement on the second measurement resource, responsive to determining that the first measurement resource and the second measurement resource are configured with a same plurality of beam states. The first measurement resource and the second measurement resource may correspond to different resource settings.

In some embodiments, the wireless communication node may transmit from to the wireless communication device, a first signal transmission corresponding to the first measurement resource and a second signal transmission corresponding to the second measurement resource, according to a plurality of beam states configured for the first measurement resource. In some embodiments, the wireless communication device may be caused to perform interference measurement on the second measurement resource using precoding information applied on the second measurement resource, responsive to receiving an indication via a higher layer signaling.

In some embodiments, the wireless communication device may be caused to perform interference measurement on the second measurement resource using precoding information applied on the second measurement resource, according to a plurality of beam states configured for the second measurement resource. In some embodiments, the plurality of beam states configured for the second measurement resource may be the same as that configured for the first measurement resources.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3A illustrates a block diagram of an example system for multiple transmission/reception point data transmission;

FIG. 3B illustrates a block diagram of an example system for enhancing channel state information on multiple transmission/reception points using channel state information measurements, in accordance with an embodiment of the present disclosure;

FIGS. 4A-D illustrate block diagrams of example resource sets used in the system for enhancing channel state information on multiple transmission/reception points, in accordance with an embodiment of the present disclosure;

FIG. 5 illustrates a block diagram of an example system for enhancing channel state information on multiple transmission/reception points using multiple transmission configuration indicator states, in accordance with an embodiment of the present disclosure;

FIG. 6 illustrate block diagram of example resource sets used in the system for enhancing channel state information on multiple transmission/reception points, in accordance with an embodiment of the present disclosure; and

FIG. 7 illustrates a flow diagram of an example method of enhancing channel state information on multiple transmission/reception points, in accordance with an embodiment of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

The following acronyms are used throughout the present disclosure:

| Acronym | Full Name |
|---|---|
| 3GPP t | 3rd Generation Partnership Project |
| 5G | 5th Generation Mobile Networks |
| 5G-AN | 5G Access Network |
| 5G gNB | Next Generation NodeB |
| 5G-GUTI 5G- | Globally Unique Temporary UE Identify |
| AF | Application Function |
| AMF | Access and Mobility Management Function |
| AN | Access Network |
| ARP | Allocation and Retention Priority |
| CA | Carrier Aggregation |
| CM | Connected Mode |
| CMR | Channel Measurement Resource |
| CSI | Channel State Information |
| CQI | Channel Quality Indicator |
| CSI-RS | Channel State Information Reference Signal |
| CRI | CSI-RS Resource Indicator |
| CSS | Common Search Space |
| DAI | Downlink Assignment Index |
| DCI | Downlink Control Information |
| DL | Down Link or Downlink |
| DN | Data Network |
| DNN | Data Network Name |
| ETSI | European Telecommunications Standards |
| | Institute |
| FR | Frequency range |
| GBR | Guaranteed Bit Rate |
| GFBR | Guaranteed Flow Bit Rate |
| HARQ | Hybrid Automatic Repeat Request |
| MAC-CE | Medium Access Control (MAC) Control |
| | Element (CE) |
| MCS | Modulation and Coding Scheme |
| MBR | Maximum Bit Rate |
| MFBR | Maximum Flow Bit Rate |
| NAS | Non-Access Stratum |
| NF | Network Function |
| NG-RAN | Next Generation Node Radio Access Node |
| NR | Next Generation RAN |
| NZP | Non-Zero Power |
| OFDM | Orthogonal Frequency-Division Multiplexing |
| OFDMA | Orthogonal Frequency-Division Multiple |
| | Access |
| PCF | Policy Control Function |
| PDCCH | Physical Downlink Control Channel |
| PDSCH | Physical Downlink Shared Channel |
| PDU | Packet Data Unit |
| PUCCH | Physical uplink control channel |
| PMI | Precoding Matrix Indicator |
| PPCH | Physical Broadcast Channel |
| PRI | PUCCH resource indicator |
| QoS | Quality of Service |
| RAN | Radio Access Network |
| RAN CP | Radio Access Network Control Plane |
| RAT | Radio Access Technology |
| RBG | Resource Block Group |
| RRC | Radio Resource Control |
| RV | Redundant Version |
| SM NAS | Session Management Non Access Stratum |
| SMF | Session Management Function |
| SRS | Sounding Reference Signal |
| SS | Synchronization Signal |
| SSB | SS/PBCH Block |
| TB | Transport Block |
| TC | Transmission Configuration |
| TCI | Transmission Configuration Indicator |
| TRP | Transmission/Reception Point |
| UCI | Uplink Control Information |
| UDM | Unified Data Management |
| UDR | Unified Data Repository |
| UE | User Equipment |
| UL | Up Link or Uplink |
| UPF | User Plane Function |
| USS | UE Specific Search Space |

### 1. Mobile Communication Technology and Environment

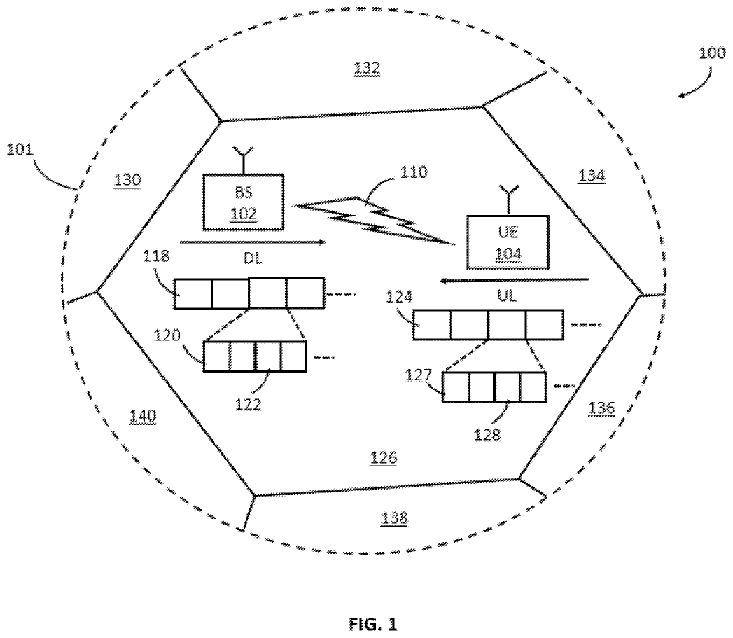

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

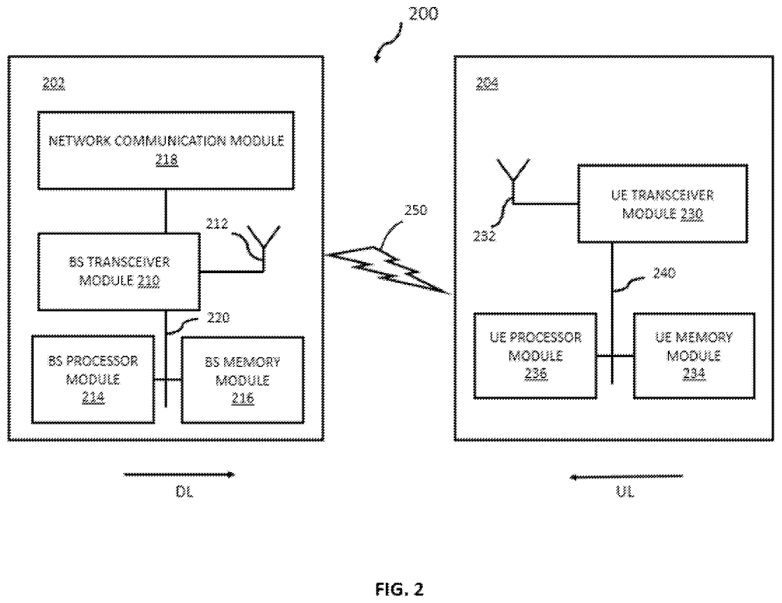

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Enhancing Channel State Information (CSI) on Multiple Transmission/Reception Points (TRP)

In NR Release15, the time and frequency resources that can be used by the UE to report CSI are controlled by the gNB. The CSI may include: a Channel Quality Indicator (CQI), precoding matrix indicator (PMI), CSI-RS resource indicator (CRI), SS/PBCH Block Resource indicator (SSBRI), layer indicator (LI), rank indicator (RI) and/or L1-RSRP. For CQI, PMI, CRI, SSBRI, LI, RI, L1-RSRP, a UE is configured by higher layers with N≥1 CSI-ReportConfig Reporting Settings, M≥1 CSI-ResourceConfig Resource Settings. One CSI Reporting Setting links to up to three CSI resource settings.

For aperiodic CSI, each trigger state configured using the higher layer parameter CSI-AperiodicTriggerState may be associated with one or multiple CSI-ReportConfig. Each CSI-ReportConfig may be linked to periodic, or semi-persistent, or aperiodic resource setting(s). When one Resource Setting is configured, the Resource Setting (given by higher layer parameter resourcesForChannelMeasurement) may be for channel measurement for L1-RSRP computation. When two Resource Settings are configured, the first Resource Setting (given by higher layer parameter resourcesForChannelMeasurement) may be for channel measurement and the second Resource Setting (given by either higher layer parameter csi-IM-ResourcesForInterference or higher layer parameter nzp-CSI-RS-ResourcesForInterference) may be for interference measurement performed on CSI-IM or on NZP CSI-RS. When three Resource Settings are configured, the first Resource Setting (higher layer parameter resourcesForChannelMeasurement) may be for channel measurement, the second Resource Setting (given by higher layer parameter csi-IM-ResourcesForInterference) may be for CSI-IM based interference measurement, and the third Resource Setting (given by higher layer parameter nzp-CSI-RS-ResourcesForInterference) may be for NZP CSI-RS based interference measurement.

For semi-persistent or periodic CSI, each CSI-ReportConfig may be linked to periodic or semi-persistent Resource Setting(s). When one Resource Setting (given by higher layer parameter resourcesForChannelMeasurement) is configured, the Resource Setting may be for channel measurement for L1-RSRP computation. When two Resource Settings are configured, the first Resource Setting (given by higher layer parameter resourcesForChannelMeasurement) is for channel measurement and the second Resource Setting (given by higher layer parameter csi-IM-ResourcesForInterference) may be used for interference measurement performed on CSI-IM.

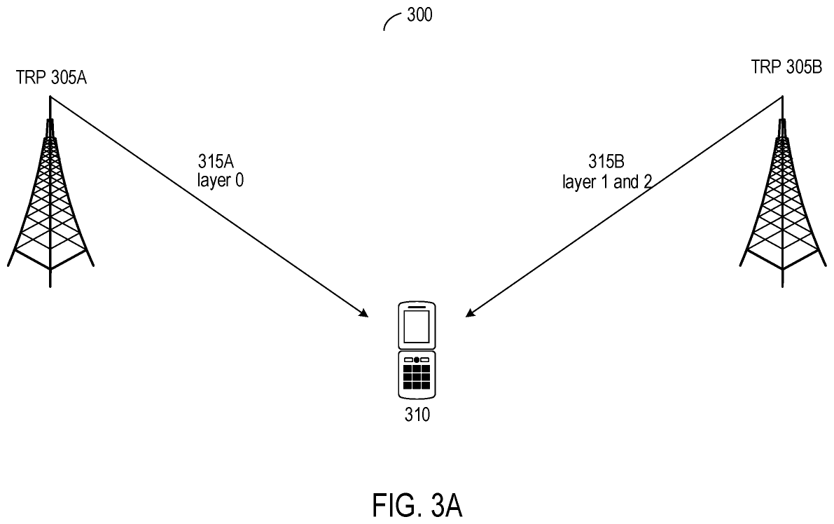

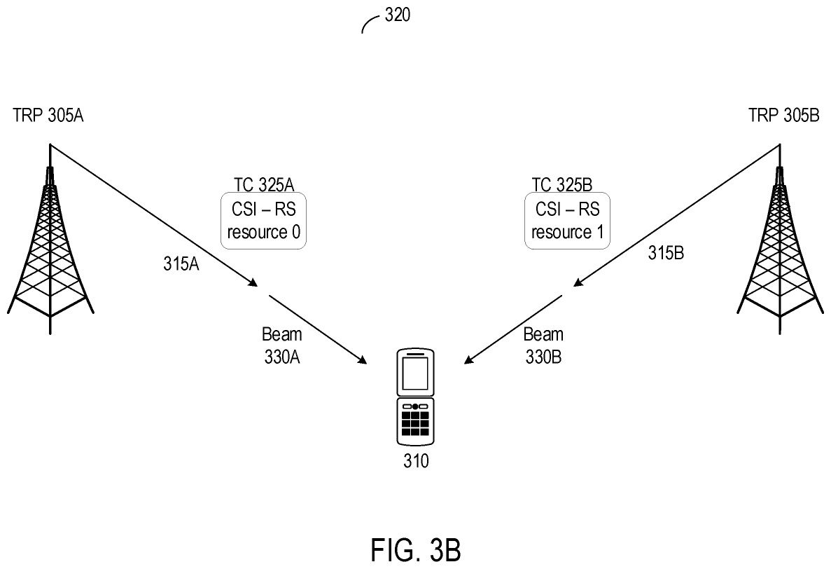

Referring now to FIG. 3A, depicted is a block diagram of a system 300 for multiple TRP data transmission as introduced in NR Release R16. As depicted, two TRPs 305A and 305B transmit one PDSCH to a UE 310 at a given time. Layer 0 may be transmitted from TRP 305A via data transmission 315A and layers 1 and 2 may be transmitted from TRP 305B via data transmission 315B. However, the CSI reporting mechanism may have some issues in supporting multi-TRP transmission in situations as in the system 300.

### A. System for Enhancing CSI on Multiple TRPs Using CSI Measurements

For LI-SINR, RI, PMI and CQI measurements, at least two measurements may be involved: a channel measurement and an interference measurement. If interference measurement is performed on CSI-IM, each CSI-RS resource for the channel measurement may be resource-wise associated with a CSI-IM resource by the ordering of the CSI-RS resource and CSI-IM resource in the corresponding resource sets. The number of CSI-RS resources for channel measurement equals to the number of CSI-IM resources.

If interference measurement is performed on NZP CSI-RS, a UE may assume that each NZP CSI-RS port configured for interference measurement corresponds to an interference transmission layer. Furthermore, the UE may also assume that all interference transmission layers on NZP CSI-RS ports for interference measurement take into account the associated EPRE ratios. In addition, the UE may also assume another interference signal on REs of NZP CSI-RS resource for channel measurement, NZP CSI-RS resource for interference measurement, or CSI-IM resource for interference measurement.

An RS (e.g., a CSI-RS resource) configured in resourcesForChannelMeasurement may be denoted as a CMR (channel measurement resource) for channel measurement. An RS (e.g., a CSI-RS resource) configured in csi-IM-ResourcesForInterference may be denoted as a CSI-IM resource. Furthermore, a RS (e.g., a NZP CSI-RS resource) configured in nzp-CSI-RS-ResourcesForInterference may be denoted as a NZP-IMR(non-zero power interference measurement resource). Both CSI-IM and NZP-IMR can be denoted as IMR (interference measurement resource).

Referring now to FIG. 3B, depicted a block diagram of a system 320 for enhancing CSI on multiple TRPs 305A and 305B using multiple measurements. As depicted, the TRP 305A may send a data transmission 315A via beam 330A to UE 310. The TRP 305B may send a data transmission 315B via beam 330B to UE 310. The NZP CSI-RS resource 0 may be configured for channel measurement in accordance with TC 325A and the NZP CSI-RS resource 1 may be configured for interference measurement in accordance with TC 325B. Each port of CSI-RS resource 1 may correspond to an interference transmission layer. One approach in calculating the SINR of CSI-RS resource 0 in TC 325A may be to use the interference from TRP 305B. However, this approach may not consider multi-TRP transmission very well since both TRPs 305A and 305B may transmit signals to UE 310.

Both NZP CSI-RS resource 0 and 1 in TC 325A and 325B can be used for channel measurement. UE 310 may calculate and feedback CSI, including RI, PMI or SINR for both CSI-RS resources. After getting the reported CSI from UE 310, two TRPs 305A and 305B may transmit PDSCH which is pre-coded based on reporting PMI. The PDSCH layers 1 and 2 may be from TRP 305B, and cause interference to be on layer 0. PDSCH layer 0 may be from TRP 305A, and may cause interference to layer 1 and 2. Each PDSCH layer may be transmitted after applying precoding.

Precoding, however, may not be applied to each port of NZP CSI-RS resource 0 in TC325A or resource 1 in TC325B since both NZP CSI-RS resource 0 and 1 are non-precoded and for PMI measurement. Hence, SINR calculation for CSI-RS resource 0 in TC 325A based on the assumption that each port of CSI-RS resource 1 may correspond to an interference transmission layer cannot reflect the real interference for data transmission.

For each CSI-RS reception, QCL or spatial relation related parameters may be configured, denoted as TCI. In high frequency bands, each TCI may correspond to one receive beam defined by a beam state. A beam state 330A or 330B may correspond or refer to one TCI or one spatial relation configuration. Because of the independent TCI configurations 325A and 325B for CSI-RS resource 0 and resource 1, UE 310 may use beam state 330A and beam state 330B to receive CSI-RS resource 0 and resource 1 respectively:

$$For CSI - RS resource 0 : {SINR}_{0} = \frac{‖ {H}_{R S 0}^{b 0} {W}_{0} + {H}_{R S 0}^{b 1} {W}_{0} ‖}{‖ {H}_{R S 1}^{b 0} {W}_{1} + {H}_{R S 1}^{b 1} {W}_{1} ‖ + {I}_{0}}$$

$$For CSI - RS resource 1 : {SINR}_{1} = \frac{‖ {H}_{R S 1}^{b 0} {W}_{1} + {H}_{R S 1}^{b 1} {W}_{1} ‖}{‖ {H}_{R S 0}^{b 0} {W}_{0} + {H}_{R S 0}^{b 1} {W}_{0} ‖ + {I}_{1}}$$

Wherein bi refers to beam i; RSi refers to CSI-RS resource i; H_{RSi}^{bj} is channel matrix between UE and CSI-RS resource i in the case when UE uses receive beam j; Wᵢ is precoding matrix which will be used by TRP i for data transmission; Iᵢ is other interference for CSI-RS resource i.; and SINRi refers to SINR for CSI-RS resource i.

To obtain the optimum the precoding matrices W₀, W₁, UE 310 may obtain channel matrix H_{RS0}^{b0}, H_{RS1}^{b0}, H_{RS1}^{b1}, H_{RS0}^{b1}. For instance, the optimum W₀, W₁ may result in the largest sum of throughput of TRP 305A and TRP 305B. The optimum W₀, W₁ may also result in the largest sum of SINR_{b0} and SINR_{b1}. The information of W₀ and W₁ can be reported to UE, and be used for data transmission by TRP 305A and TRP 305B respectively.

In obtaining, the UE 310 may receive CSI-RS resource 0 in TC 325A based on beam state 330A and beam 330B in order to obtain H_{RS0}^{b0} and H_{RS0}^{b1}. For SINR_{b0} calculation, the interference part caused by CSI-RS resource 1 in TC 325B should consider the precoding matrix of W₁. Furthermore, UE 310 may receive CSI-RS resource 1 in TC 325B based on beam state 330A and beam state 330B in order to obtain H_{RS1}^{b1} and H_{RS1}^{b1}. For SINR_{b1} calculation, the interference part caused by CSI-RS resource 0 should consider the precoding matrix of W₀.

To fulfill the above requirement, the association may be set up among X1>=2 CMRs within at least one Resource Setting. For CSI or L1-SINR measurement, when a CMR m is used for channel measurement, other CMR(s) associated with CMR m is used for interference measurement. In other words, an CMR n associated with CMR m may be as an IMR of CMR m. For interference measurement is performed on an CMR n, a UE 310 assumes the precoding matrix or RI/PMI is applied on the CMR n. The precoding matrix or RI/PMI calculation is based on CMR n and based on TCI (or TCIs 325A or 325B) configured or assumed or used for CMR n. The association can be configured by higher layer signaling(RRC or MA-CCE) or by implicit signaling.

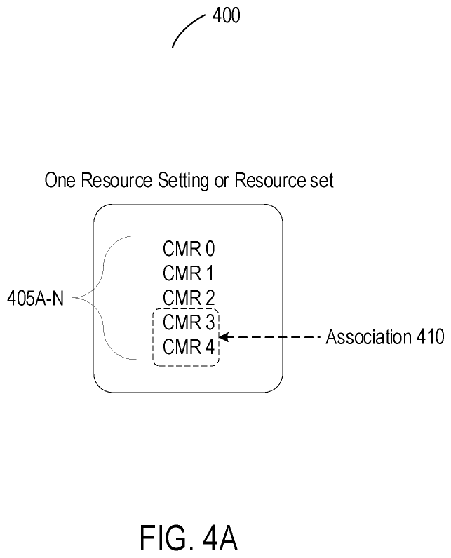

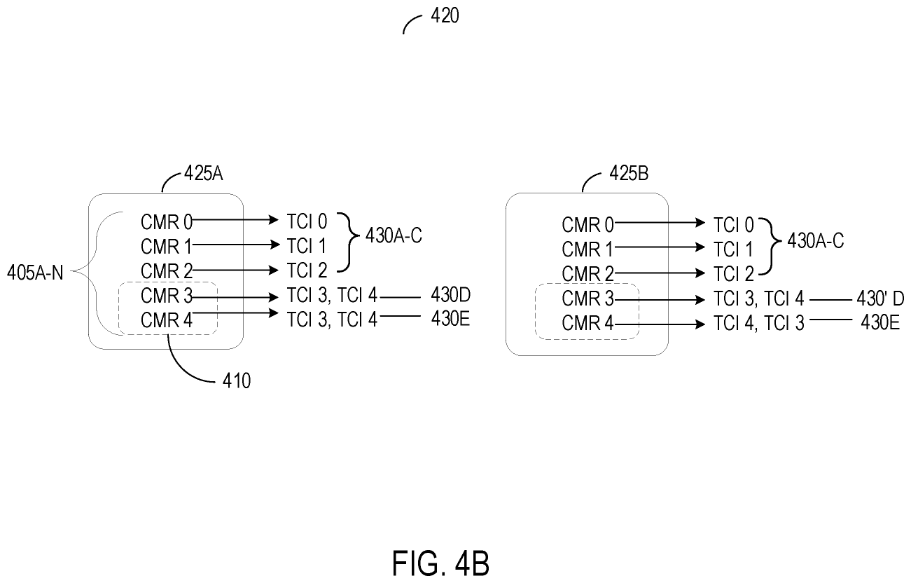

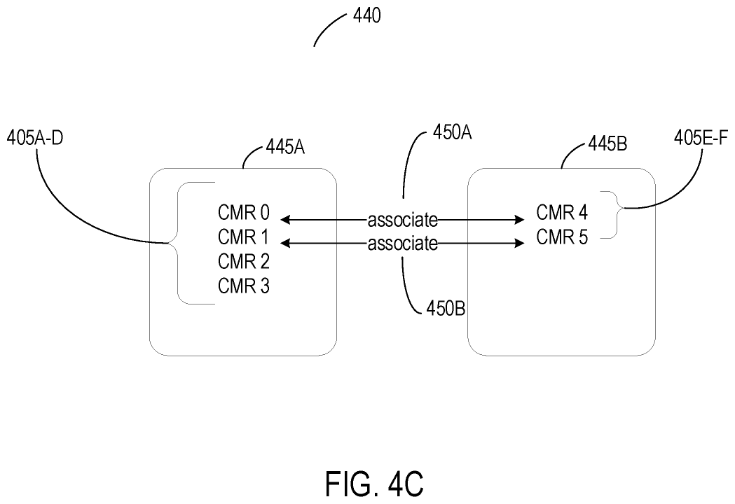

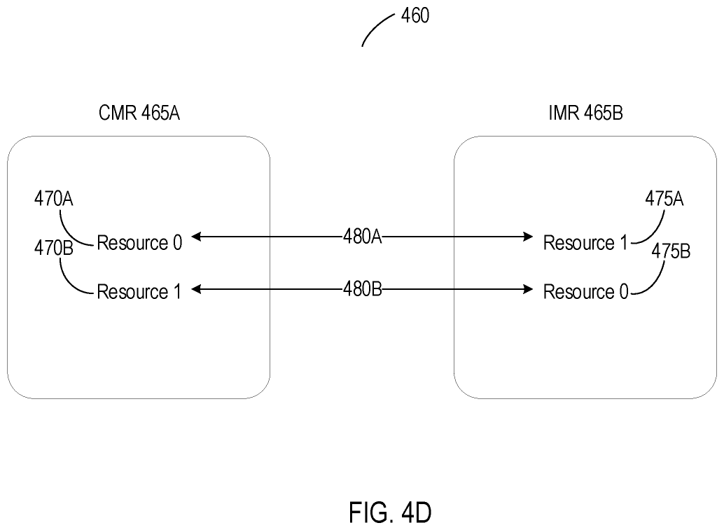

Referring now to FIG. 4A, depicted is a block diagram of a Resource Setting 400 for use the system 300 for enhancing CSI on multiple TRPs 305A and 305B. For reception of each of associated CMRs 410 (e.g., CMR 3 and CMR 4 in CMRs 405A-N as depicted), UE 310 obtains the quasi-colocation (QCL) type D from TCI states 325A and 325B configured to all associated CMRs 410 (e.g., CMR 3 and CMR 4 as depicted). In other words, UE 310 assumes multiple QCL type D for each of associated CMRs 410. UE 310 can obtain other QCL type from TCI state configured to each CMR 410 for each of associated CMRs.

For reception of each of associated CMRs 405, UE 310 obtains the QCL assumptions from TCI states configured to all associated CMRs 405. In other words, UE 310 assumes multiple QCL assumptions or TCI states 325A and 325B for each of associated CMRs 405. In other words, UE 310 receives each of associated CMRs 405 based on multiple TCI states 325A and 325B which are configured for all associated CMRs 405. For instance, five CMRs 0-5 are configured within one Resource setting or resource set 400 for channel measurement. CMR 3 and CMR 4 are associated. One TCI state is configured by RRC signaling or activated by MA-CCE for each CMR. Assuming TCI state n is configured for CMR n. Then, UE 310 receives CMR 3 based on both TCI state 3 and 4. Also, UE receives CMR 4 based on both TCI state 3 and 4. If CMR 3 is for channel measurement, CMR 4 is as an IMR for interference measurement and UE 310 assumes the precoding matrix or RI and PMI is applied on CMR 4.

The CSI based on CMR 3 for channel measurement and based on CMR 4 and some other IMRs for interference measurement may be denoted as CSI 3 which can include RI1, PMI1 and CQI1. If CMR 4 is for channel measurement, CMR 3 is as an IMR for interference measurement and UE 310 assumes the precoding matrix or RI and PMI is applied on CMR 3. The CSI based on CMR 4 for channel measurement and based on CMR 3 and some other IMRs for interference measurement is denoted as CSI 4 which can include RI2, PMI2 and CQI2. If CRI corresponding to CMR3 is reported by UE 310, CSI 3 is reported to network side. If CRI corresponding to CMR4 is reported by UE 310, CSI 4 is reported to network side.

UE 310 can report one CRI corresponding to multiple associated CMRs. In this case, two bits may be enough for CRI feedback to indicate CMR 0, CMR 1, CMR 2 and (CMR3, CMR4) respectively. If the report CRI corresponds to (CMR3, CMR4), the reported CSI include RI1, RI2, PMI1, PMI2, CQI1 and CQI 2. In other words, UE 310 can report one CRI corresponding to multiple associated CMRs, and report multiple RI, PMI and CQI. Also, UE 310 can report one CRI corresponding to multiple L1-SINR, or L1-RSRP. The number of RI, PMI and CQI is equal to the number of associated CMRs, e.g., 2 in FIG. 4A. CQI 1 and CQI 2 can be combined. UE 310 can report one CRI corresponding to multiple associated CMRs, and report multiple RI, PMI and a combined CQI. The number of RI, PMI and CQI is equal to the number of associated CMRs (e.g., as shown in association 410). Also, UE 310 can report one CRI corresponding to multiple associated CSI-RS resources (or other RS resources, e.g. multiple associated SSB indices) and report one combined L1-SINR, or L1-RSRP.

Referring now to FIG. 4B, depicted is a block diagram of a set 420 of resource settings 425A and 425B for use in the system 300. A gNB can use implicit signaling to inform UE 310 which CMRs 405 are associated. Configuring or activating the same TCI states to the CMRs which are associated may be used. That is, if two CMRs are configured with the same TCI states, they are associated. Then, additional RRC or MA-CCE signaling is saved. For each of M associated CMRs 405 (in association 410), M same TCI states 430A-E (hereinafter generally referred to as 430) are configured. For instance, M=2 as shown in the resource settings 425A and 425B. In the resource setting 425B, the same TCI states with different order are configured to the associated CMRs 405. For reception of each of associated CMRs 405, UE 310 obtains the QCL assumptions from TCI states 430 configured to its own TCI states.

Referring now to FIG. 4C, depicted is a block diagram of a set 440 of resource settings 445A and 445B for use in the system 300. To set up the association of some CMRs 405, two sets or groups 450A and 450B of CMR resources within one Resource setting or two Resource settings within one CSI reporting setting are configured or activated or indicated. The CMRs 405 in the first set or group are resource-wise associated with the CMRs 405 in the second set 450B. That is, the x^{th} CMR in the first set or group is associated with the x^{th} CMR 405 in the second set or group 450B. It is noted that the number of CMRs 405 in the two sets or groups 450A and 450B may not be the same. Regarding CRI feedback, the relative resource index within one of two sets or groups 450A and 450B may be used. Specifically, the CRI within the set or group with more CMRs 405 is reported to gNB. In this case, two bits may be enough for CRI feedback to indicate (CMR 0, CMR4), (CMR 1, CMR5), CMR 2 and CMR3 respectively. That is, UE 310 reports one CRI corresponding to multiple associated CMRs 405, and report multiple RI, PMI and CQI. For L1-SINR measurement, UE 310 reports one CRI corresponding to multiple associated CMRs 405, and report multiple L1-SINR or L1-RSRP. The number of RI, PMI, CQI, L1-SINR, or L1-RSRP is equal to the number of associated CMRs 405. One CQI may be used. UE 310 can report one CRI corresponding to multiple associated CMRs 405, and report multiple RI, PMI and a combined CQI. The number of RI, PMI and CQI is equal to the number of associated CMRs 405. For L1-SINR measurement, UE 310 can report one CRI corresponding to multiple associated CMRs 405, and report a combined L1-SINR.

Referring now to FIG. 4D, depicted is a block diagram of a set 460 of resource settings 465A and 465B for use in the system 300. For an CMR m, to set up the association 480A and 48B with another CMR n, an IMR in the IMR set 465B may be configured with the same resource index with CMR n in the CMR set 465A. Then, the interference measurement will be based on the IMR 465B since one IMR 475A or 475B is the same as the associated CMR 470A or 470B. In this case, the UE 310 may assume the precoding matrix or RI/PMI based on CMR n will be applied on the IMR for interference measurement. As shown, CSI-RS resource 1 is an CMR, it is also an IMR which corresponds to CMR 0.

### B. System for Enhancing CSI on Multiple TRPs Using Multiple TCI States

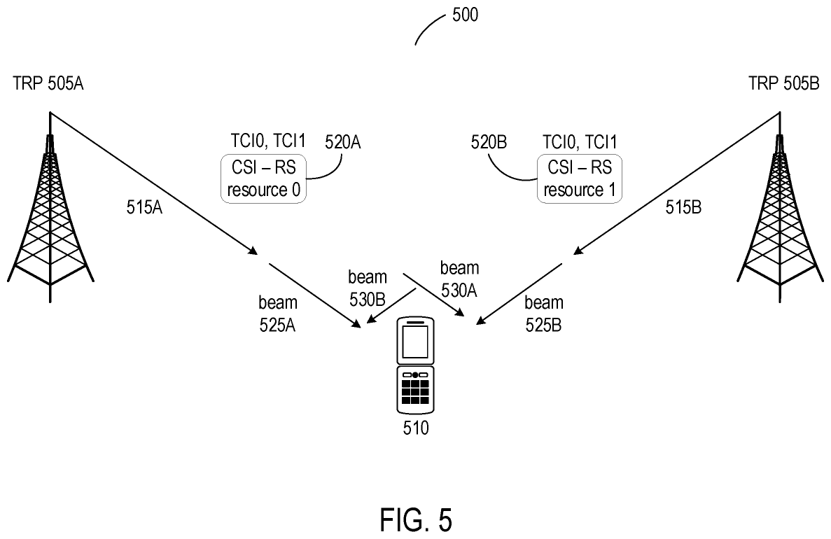

Referring now to FIG. 5, depicted is a block diagram of a system 500 for enhancing channel state information on multiple transmission/reception points using multiple transmission configuration indicator states. In contrast to system 500, the system 300 may rely define the association between two CMRs. When a CMR m is used for channel measurement, other CMR(s) associated with CMR m may be used for interference measurement.

Another approach may be to not rely on the association between two CMRs. In this case, an CMR and an IMR of this CMR can be configured with same M TCI states (the order may be the same or different) as in 505A and 505B, M>1. For CSI or L1-SINR measurement, when a CMR m configured(or activated by MA-CCE or indicated by DCI) with M TCI states 505A and 505B is used for channel measurement, a corresponding IMR n used for interference measurement is also configured with the same M TCI states 505A and 505B. Then, the UE 310 receives the CMR and the IMR based on the configured, activated, or indicated M TCI states. If channel measurement is based on CMR m, IMR n is used for interference measurement, and the UE 310 assumes the precoding matrix or RI/PMI is applied on the IMR n for interference measurement. The precoding matrix or RI/PMI calculation is based on IMR n and based on TCIs configured/activated/indicated or assumed or used for the IMR n, i.e. the M TCI states 505A and 505B.

For instance, M=2. Compared with FIG. 3A, CSI-RS resource 0 and resource 1 are configured as CMR and IMR respectively as shown in FIG. 3B. Both two resources are configured with two TCI states, i.e. TCI 0 and TCI 1. Then, UE 310 uses two corresponding beams 510A and 510B to receive CSI-RS resource 0 and resource 1. If reported CRI corresponds to the CMR m (m=0), channel measurement is based on CMR m, IMR n(n=1) is used for interference measurement, and the UE 310 will apply the precoding matrix or RI/PMI on the IMR n for interference measurement. The precoding matrix or RI/PMI calculation is based on IMR n and based on TCI 0 and TCI 1.

Regarding CSI feedback, if the reported CRI corresponds to this CMR m, RI/PMI/CQI or L1-SINR feedback may be based on CMR m for channel measurement and/or based on IMR n for interference measurement. Specifically, the feedback CQI corresponds to:

$${SINR}_{0} = \frac{‖ {H}_{R S 0}^{b 0} {W}_{0} + {H}_{R S 0}^{b 1} {W}_{0} ‖}{‖ {H}_{R S 1}^{b 0} {W}_{1} + {H}_{R S 1}^{b 1} {W}_{1} ‖ + {I}_{0}}$$

For CSI feedback, if the reported CRI corresponds to this CMR m, multiple RI/PMI/CQI or L1-SINR feedback can be reported. For instance, RI0 or PMI0 or CQI0 or L1-SINR0 is based on CMR m for channel measurement and/or based on IMR n for interference measurement. RI1 or PMI1 or CQI1 is based on IMR n for channel measurement and/or based on CMR m for interference measurement. For RI0, PMI0 or CQI0 or L1-SINR0 calculation, UE 310 assumes the precoding matrix or RI1/PMI1 is applied on the IMR n for interference measurement. For RI1, PMI1 or CQI1 or L1-SINR1 calculation, UE 310 assumes the precoding matrix or RI0/PMI0 is applied on the CMR m for interference measurement.

So the feedback CQI 0 corresponds to:

$${SINR}_{0} = \frac{‖ {H}_{R S 0}^{b 0} {W}_{0} + {H}_{R S 0}^{b 1} {W}_{0} ‖}{‖ {H}_{R S 1}^{b 0} {W}_{1} + {H}_{R S 1}^{b 1} {W}_{1} ‖ + {I}_{0}}$$

Furthermore, the feedback CQI 1 corresponds to:

$${SINR}_{1} = \frac{‖ {H}_{R S 1}^{b 0} {W}_{1} + {H}_{R S 1}^{b 1} {W}_{1} ‖}{‖ {H}_{R S 0}^{b 0} {W}_{0} + {H}_{R S 0}^{b 1} {W}_{0} ‖ + {I}_{1}}$$

Moreover, to save feedback overhead, CQI 0 and CQI 1 can be combined to one CQI if RI0+RI1<=4. So UE 310 can report RI0, RI1, PMI0, PMI1 and one CQI. Likewise, a L1-SINR can be reported. It is noted that multiple NZP-IMR can be configured to associate with one CMR. In this case, some NZP-IMR can be configured with only one TCI.

Both CMR and IMR may be configured with the same M TCI states. The configuration signaling is too restrictive. In some embodiments, M TCI states may be configured for a CMR m. M TCI states are not required for the IMR configuration. Then, the UE 310 receives the CMR and the IMR based on the configured/activated/indicated M TCI states.

Usually, each NZP-IMR port configured for interference measurement corresponds to an interference transmission layer. That is, UE does not apply RI, PMI on an NZP-IMR for interference measurement. However, UE needs to consider applying RI/PMI on NZP-IMR in the above solutions for multi-TRP transmission. Hence, two types of NZP-IMR may be supported.
Type 1: for an NZP-IMR for interference measurement, each NZP-IMR port corresponds to an interference transmission layer;
Type 2: for an NZP-IMR for interference measurement, the precoding information, e.g. precoding matrix or RI/PMI is applied on the IMR n for interference measurement.

If multiple NZP-IMR are configured corresponds to one CMR, some explicit or implicit signaling should be used to inform UE if an IMR is type 1 or type 2. Specifically, some explicit or implicit signaling should be used to inform UE if the precoding information, e.g. precoding matrix or RI/PMI will be applied on an IMR for interference measurement.

Higher layer signaling may also be used. For instance, RRC signaling is configured to an IMR to inform UE if the precoding matrix or RI/PMI will be applied on the IMR for interference measurement.

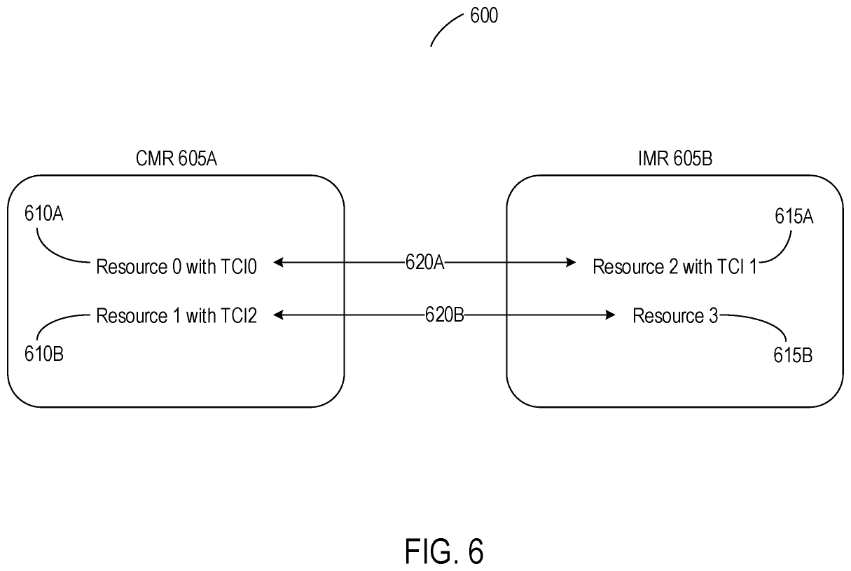

Referring now to FIG. 6, depicted is a block diagram of a set 600 of resource sets 605A and 605B used in the system 300 or 500. For an type 2 NZP-IMR, UE receives both the corresponding CMR and the NZP-IMR based on all TCI states which are configured for the corresponding CMR and the NZP-IMR. As shown in FIG. 6, UE will receive both resource 0 and resource 2 based on both TCI 0 and TCI 1 if resource 2 is an type 2 NZP-IMR although only one TCI is configured for CMR or IMR.

The configured TCI states may be used to implicitly indicate the IMR type. For instance, if the number of configured TCI states for an IMR is larger than 1, the precoding matrix or RI/PMI will be applied on the IMR for interference measurement. Otherwise, each NZP-IMR port corresponds to an interference transmission layer.

### C. System for Enhancing CSI on Multiple TRPs Using one TCI State

In system 300, the UE may consider precoding applying to an resource for interference measurement. However, whether and how to apply the precoding to the resource may be up to UE implementation. The UE behavior for interference measurement on the IMR may differ with an NZP-IMR wherein each NZP-IMR port corresponds to an interference transmission layer for interference measurement (Type 1 IMR).

Some explicit or implicit signaling should be used to inform UE if each NZP-IMR port corresponds to an interference transmission layer or not. Higher layer signaling may be used. The configured, activated, or indicated TCI state(s) to the IMR may be used. For instance, if the number of configured TCI states for the IMR is larger than 1, the IMR is the new type which is different with Type 1 IMR. Moreover, an exact example is that an IMR is the new type if it is configured with M>1 TCI states which are the same as configured for the corresponding CMR.

For the new type NZP-IMR as depicted in set 600, if only one TCI 615A is configured for CMR 605A or IMR 605B, UE 310 can receive both the corresponding CMR and the NZP-IMR based on all TCI states (e.g., 610A-C) which are configured for the corresponding CMR 605A and the NZP-IMR.

In some embodiments, if M TCI states (e.g., 610A-C) are configured for the CMR 605A, UE 310 may receive both CMR 605A and IMR 605B based on the M TCI states (e.g., 610A-C). In this case, the same M TCI states (e.g., 615A) may be configured to the type of IMR 605B.

Regarding CSI report, one or two sets of CSI are reported. One set of CSI report includes one RI, one PMI, or one CQI. Alternatively, one set of CSI report refers to one set of LI-SINR. One set of CSI report corresponds to one CMR. Two sets of CSI report corresponds to two CMRs. In some embodiments, two CMRs can be associated (e.g., using associations 620A and 620B). When a CMR m is used for channel measurement, other CMR(s) associated with CMR m is used for interference measurement

### D. Methods of Enhancing CSI on Multiple TRPs

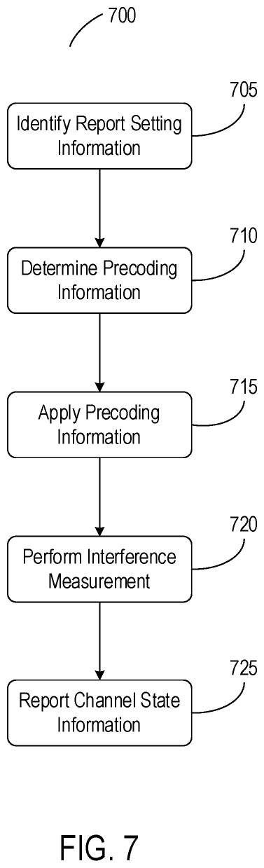

FIG. 7 illustrates a flow diagram of a method 700 of enhancing channel state information on multiple transmission/reception points. The method 700 may be implemented using any of the components and devices detailed herein in conjunction with FIGS. 1-6. In overview, the method 700 may include identifying report setting information (705). The method 700 may include determining precoding information (710). The method 700 may include applying the precoding information (715). The method 700 may include performing interference measurement (720). The method 700 may include reporting channel state information (725).

In further detail, the method 700 may include identifying report setting information (705). To calculate more accurate interference, a wireless communication node (e.g., an eNB or TRP 305A or 305B) may send, provide, or transmit a reporting setting information for associated measurements to a wireless communication device (e.g., the UE 310). The reporting setting information may define resources (e.g., time and frequency band) to be measured by the wireless communication device for transmission of data between the wireless communication node and the wireless communication device. The associated measurement resources may include a first measurement resource for channel measurement (e.g., CSI-RS Resource 0 in TC 325A), and a second measurement resource. The second measurement resource may also be for channel measurement (e.g., CSI-RS Resource 1 in TC 325B).

In some embodiments, the reporting setting information or a resource setting information configured in accordance with the reporting setting information may define, identify, or include an association (e.g., association 410) between the first measurement resource and the second measurement resource. The association may define a grouping or correspondence among one or more measurement resources, such as the first measurement resource and the second measurement resource. The wireless communication device (e.g., the UE 310) may in turn identify, retrieve, or receive a reporting setting information for associated measurement resources from the wireless communication node (e.g., an eNB or TRP 305A or 305B). The reporting setting information or the resource setting information received from the wireless communication node may indicate an association (e.g., association 410) between the first measurement resource and the second measurement resource.

In some embodiments, the report setting information or the resource setting information configured in accordance with the report setting information may define, identify, or indicate that the first measurement resource (e.g., 405) is in a first set of measurement resources (e.g., 425A) and the second measurement resource (e.g., 405) is in a second set of measurement resources (e.g., 425B). The first measurement resource may be at a position in the first set of measurement resources. The second measurement resource may be at a position in the second set of measurement resources. The position for the measurement resource may indicate an index or a rank within the respective set. The position of the second measurement resource in the second set of measurement resources may correspond to the position of the first measurement resource in the first set of measurement resources. In some embodiments, the report setting information or the resource setting information configured in accordance with the report setting information may define, identify, or indicate that the second measurement resource (e.g., IMR) has the position or (a resource index) that is the same as a position of a third measurement resource for channel measurement (e.g., CMR 405).

The method 700 may include determining the precoding information (710). With receipt of the reporting setting information, the wireless communication device (e.g., the UE 310) may determine the precoding information to apply on the second measurement resource. The precoding information may be used by the wireless communication node in data transmissions to the wireless communication device. The precoding information may include, for example, a precoding matrix, a precoding matrix indicator, or a rank indicator, among others. The precoding matrix may define beamforming (e.g., beam states 330A or 330B) and power allocation for the data transmission from the wireless communication node (e.g., eNB or TRP 305A or 305B). The precoding matrix indicator (PMI) may reference the settings for the precoding matrix to be applied in data transmission. The rank indicator (RI) may define control information to be reported by the wireless communication device (e.g., UE 310) to wireless communication node (e.g., eNB or TRP 305A or 305B). In some embodiments, the wireless communication device may determine the precoding information for the second measurement resource (e.g., 405) according to the third measurement resource (e.g., 475A or 475B in IMR 465B). The third measurement resource may be of a different resource setting as the second measurement resource.

The precoding information may be determined according to at least one beam state (e.g., beam states 330A or 330B) for the second measurement resource. Each beam state 330A or 330B may include quasi-colocation (QCL) configuration or a spatial relation configuration, among others. The quasi-colocation configuration may indicate that a beam transmitted in accordance with the beam state (e.g., beam states 330A or 330B) is transmitted from different antenna ports with similar or same properties such as Doppler spread, Doppler shift, delay, delay spread, and beam forming properties, among others. The spatial relation configuration may indicate that a beam transmitted in a beam state (e.g., beam states 330A or 330B) is transmitted from different antenna ports with coherent properties, such as Doppler spread, Doppler shift, delay, delay spread, and beam forming properties, among others.

In obtaining the beam states, in some embodiments, the wireless communication node may provide, send, or transmit a signal corresponding to the first measurement resource or the second measurement resource to the wireless communication device. The first measurement resource may be transmitted in accordance with the first beam state (e.g., beam state 330A) and the second measurement resource may be transmitted in accordance with the second beam state (e.g., beam state 330B). Each of the beam states in the transmission may include QCL configuration or the spatial relation configuration. In some embodiments, the wireless communication device in turn may identify, retrieve, or receive the signal corresponding to the first measurement resource or the second measurement resource form the wireless communication device.

In some embodiments, the wireless communication node (e.g., TRP 305A) may transmit a first signal transmission that corresponds to the first measurement resource to the wireless communication device (e.g., UE 310). The same (e.g., TRP 305A) or another wireless communication node (e.g., TRP 305B) may transmit a second signal transmission that corresponds to the second measurement resource. The transmission of the first signal transmission or the second signal transmission may be in accordance with beam states configured for the first measurement resource. In some embodiments, the wireless communication device (e.g., UE 310) may receive the first signal transmission that corresponds to the first measurement resource from the wireless communication node (e.g., TRP 305A). In some embodiments, the wireless communication device (e.g., UE 310) may receive the first signal transmission that corresponds to the first measurement resource from the same (e.g., TRP 305A) or another wireless communication node (e.g., TRP 305B). The receipt of the first signal transmission or the second signal transmission may be in accordance with beam states configured for the first measurement resource.

With the receipt or identification of the beam states (e.g., beam states 330A or 330B), the wireless communication device (e.g., UE 310) may determine whether the first measurement resource and the second measurement resource are associated. In determining, the wireless communication device may compare the first beam state (e.g., beam state 330A) for the first measurement source and the second beam state for the second measurement source (e.g., beam state 330B). When the first beam state and the second beam state are determined to differ, the wireless communication device may determine that the first measurement resource and the second measurement resource are configured with the different beam states. Furthermore, the wireless communication device may determine that the first measurement resource and the second measurement resource are not associated.

Conversely, when the first beam state and the second beam state are determined to be the same, the wireless communication device may determine that the first measurement resource and the second measurement resource are configured with the same beam states. Furthermore, the wireless communication device may determine that the first measurement resource and the second measurement resource are associated. In some embodiments, the wireless communication device (e.g., UE 310) may determine whether to perform the interference measurement on the second measurement resource, when the first measurement resource and the second measurement resource are determined to be configured with the same beam state. The first measurement resource and the second measurement resource may correspond to different resource settings (e.g., resource settings 425A and 425B or 605A and 605B).

The method 700 may include applying the precoding information (715). The wireless communication device (e.g., UE 310) may apply (e.g., multiply or combine) the precoding information on the second measurement resource (e.g., CMR or IMR). In some embodiments, the wireless communication device may apply the precoding matrix on the second measurement resource. In some embodiments, the wireless communication device may apply the precoding matrix indicator on the second measurement resource. In some embodiments, the wireless communication device may apply the rank indicator on the second measurement resource. In applying the precoding information, the wireless communication device may output a resultant resource measurement (e.g., a sum or product) to use in calculating interference.

The method 700 may include performing interference measurement (720). The wireless communication device (e.g., UE 310) may perform the interference measurement (e.g., SINR) on the second measurement resource using the precoding information applied on the second measurement resource. In some embodiments, the wireless communication device may perform the interference measurement on the second measurement resource in response to receipt or identification of an indication via a higher layer signaling. The indication of the higher layer signaling may be received from the wireless communication node. The higher layer signaling may indicate a configuration that the data transmission uses RRC or MA-CCE. In some embodiments, the wireless communication device may perform the interference measurement on the second measurement resource according to the beam states (e.g., 330A or 330B) configured for the second measurement resource. For example, the wireless communication device may use a different channel matrix based on the beam state configured for the second measurement resource. In some embodiments, the beam states for the second measurement resource may be the same as the beam states configured for the first measurement resource.

The method 700 may include reporting channel state information (725). In some embodiments, the wireless communication device may send, transmit, or report a channel state information (CSI) reference signal (RS) resource indicator. The CSI RS resource indicator may correspond to associated measurement resources (e.g., CMR or IMR). The CSI RS resource indicator may be sent to the wireless communication node from which the reporting setting information is received or identified. In some embodiments, the wireless communication device may send, transmit, or report CSI, such as CQI, PMI, SSBRI, LI, RI, or L1-RSRP, among others. The number of CSI reported may equal a number of measurement resources in the associated measurement resources. The CSI may be reported by the wireless communication node to the wireless communication node from which the reporting setting information is received or identified. In some embodiments, the wireless communication device may send, transmit, or report a combined channel quality information. The combined channel quality information may correspond to measurement sources in the associated measurement resources. The combined channel quality information may be based on an combination (e.g., a sum or product) of any number of the CSI, such as CQI, PMI, SSBRI, LI, RI, or L1-RSRP, among others.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising,
receiving, by a wireless communication device, a reporting setting information for a plurality of associated measurement resources that comprises a first measurement resource for channel measurement, and a second measurement resource; and
performing, by the wireless communication device using precoding information applied on the second measurement resource, interference measurement on the second measurement resource.

2. The method of claim 1, wherein the precoding information comprises at least one of a precoding matrix, a precoding matrix indicator, or a rank indicator.

3. The method of claim 1, wherein the second measurement resource comprises a measurement resource for channel measurement.

4. The method of claim 3, wherein the reporting setting information, or a resource setting information configured according to the reporting setting information, includes an association between the first and the second measurement resources.

5. The method of claim 1, further comprising determining, by the wireless communication device, the precoding information according to at least one beam state used for the second measurement resource, each of the at least one beam state comprising quasi-colocation (QCL) or spatial relation configuration.

6. The method of claim 1, further comprising receiving, by the wireless communication device, a signal transmission corresponding to the first measurement resource or the second measurement resource according to at least one of: a first beam state for the first measurement resource or a second beam state for the second measurement resource, each beam state comprising quasi-colocation (QCL) or spatial relation configuration.

7. The method of claim 1, further comprising reporting, by the wireless communication device, a channel state information (CSI) reference signal (RS) resource indicator, corresponding to associated measurement resources in the plurality of associated measurement resources.

8. The method of claim 1, further comprising reporting, by the wireless communication device, a number of at least one of: rank indicator, precoding matrix indicator or channel quality information, equal to a number of measurement resources in the plurality of associated measurement resources.

9. The method of claim 1, further comprising reporting, by the wireless communication device, a combined channel quality information corresponding to measurement resources in the plurality of associated measurement resources.

10. The method of claim 1, further comprising determining, by the wireless communication device, that the first measurement resource and the second measurement resource are associated, responsive to determining that the first measurement resource and the second measurement resource are configured with a same plurality of beam states.

11. The method of claim 3, wherein the reporting setting information, or a resource setting information configured according to the reporting setting information, indicates that the first measurement resource is in a first set of measurement resources, and the second measurement resource is in a second set of measurement resources at a position corresponding to that of the first measurement resource in the first set.

12. The method of claim 1, wherein the reporting setting information indicates that the second measurement resource has a resource index that is same as that of a third measurement resource which is for channel measurement.

13. The method of claim 12, further comprising determining, by the wireless communication device, the precoding information for the second measurement resource according to the third measurement resource.

14. The method of claim 1, further comprising determining, by the wireless communication device, to perform the interference measurement on the second measurement resource, responsive to determining that the first measurement resource and the second measurement resource are configured with a same plurality of beam states, wherein the first measurement resource and the second measurement resource correspond to different resource settings.

15. The method of claim 1, further comprising receiving, by the wireless communication device, a first signal transmission corresponding to the first measurement resource and a second signal transmission corresponding to the second measurement resource, according to a plurality of beam states configured for the first measurement resource.

16. The method of claim 1, comprising performing, by the wireless communication device using precoding information applied on the second measurement resource, interference measurement on the second measurement resource, responsive to receiving an indication via a higher layer signaling.

17. The method of claim 1, comprising performing, by the wireless communication device using precoding information applied on the second measurement resource, interference measurement on the second measurement resource, according to a plurality of beam states configured for the second measurement resource.

18. The method of claim 17, wherein the plurality of beam states configured for the second measurement resource is same as that configured for the first measurement resource.

19. A wireless communication device, comprising, at least one processor configured to:
receive, via a receiver, a reporting setting information for a plurality of associated measurement resources that comprises a first measurement resource for channel measurement, and a second measurement resource; and
perform, using precoding information applied on the second measurement resource, interference measurement on the second measurement resource.

20. The wireless communication device of claim 19, wherein the precoding information comprises at least one of a precoding matrix, a precoding matrix indicator, or a rank indicator.
